(19) United States
(12) Patent Application Publication
(10) Pub. No.: US 2007/0035249 A1
(43) Pub. Date: Feb. 15, 2007

(54) Lamp with inner capsule

(76) Inventors: Geza Cseh, Budapest (HU); Peter Lajos Nagy, Budapest (HU); Ferenc Fazekas, Budapest (HU)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/200,571

(22) Filed: Aug. 10, 2005

(51) Int. Cl. H01J 17/18

(52) U.S. Cl. 313/623

(57) ABSTRACT

A lamp with an inner capsule having lead wires comprises an outer envelope, a lamp base at the end of the outer envelope, a stem formed at the base in a location predetermined relative to the outer envelope of the lamp, and lead-out wires protruding out of the stem. The inner capsule has a pinch portion and lead-in wires protruding out of the inner capsule at least partially parallel to the central plane of the pinch portion. The lead-in wires and the lead-out wires constitute pairs of lead wires providing mechanical and electrical connection between the stem and the inner capsule. Each pair of lead wires comprises a substantially straight wire of a predetermined diameter and a spooled wire of a spooling core diameter being not smaller than said predetermined diameter, and the pairs are mounted by pushing the straight wire through the core of the spooled wire.

### BACKGROUND OF THE INVENTION

This invention relates to a lamp with an inner capsule, more particularly, to an inner capsule connected to a stem of the lamp.

In case of different lamps mounted with inner burner capsule, such as, for example, Haloreflectors, a double envelope structure is formed during manufacturing the lamp. The lamp is provided with a base at the end of the outer envelope, while a stem is formed at the base in a location predetermined relative to the outer envelope. The light-emitting capsule is generally mounted upon a stem being hermetically sealed to the outer envelope. Lead-out wires protrude out of the stem within the sealed space. The inner capsule has a substantially plane pinch portion and lead-in wires are used that protrude out of the inner capsule.

U.S. Pat. No. 4,673,840 discloses a rugged mount structure for supporting a hard glass light-emitting capsule within a soft glass outer envelope. The capsule is mounted upon a soft glass stem by means of a pair of lead-in wires. These wires comprise proximal portions, which form a hermetic seal with distal portions of the stem that form a hermetic seal with the capsule and extend internally thereof and mount a tungsten filament; and intermediate portions connecting the proximal and distal portions. The intermediate portions have ends engaged by the capsule and the stem; also, the intermediate portions have greater structural rigidity than the proximal and distal ones. This construction, however, does not allow the capsule to be positioned easily during manufacturing.

If the lead wires are separated to lead-in wires to the capsule and lead-out wires to the stem, the process of positioning them to each other during manufacturing requires a quite complicated technology. Commonly used lamps comprise a metal clip around the pinch portion of the capsule for promoting mounting and fixation of the inserted capsule. Alternatively, a specially shaped metal part around the pinch portion of the inner capsule is used. Such a construction is, for example, described in U.S. Pat. No. 6,774,563. In this document, a support device is provided for use with an electric lamp having an inner capsule. Due to the special geometry of the lamps, such as, for example G9 lamps, a considerable part of the radiated visible and infrared light departs from the lamp at the pinch portion area. In the known structures, the pinch portion is surrounded by a non-transparent metallic element, which results in a considerable light waste at the pinch portion. Furthermore, said metallic element has a heat-retaining feature, causing a higher lamp working temperature. This is a consequence from the fact that any metal part around the pinch portion reflects the radiated light and heat back that may considerably increase the temperature of the pinch portion. This rise in temperature can cause failure due to an internal oxidation of the usual Molybdenum foil in the pinch portion region, and introduction of harmful thermo-mechanical stress. Other damaging mechanical stresses can also be induced by the unfitting pinch portion geometry, if the pinch portion is clipped too tightly around. On the other hand, if the clip fits loose, the displacement of the insert lamp is allowed to a certain degree. Very often, this can lead to the detachment of the weld between the lead wires of the insert and the stem. It is to be noted that the number of metal parts required for manufacturing and also the number of processing steps increase the total costs of the lamp significantly.

Thus there is a particular need for a lamp with an appropriate connection structure between the stem and the inner capsule, which provide easy manufacturing, shock-resistant mounting and even good thermal characteristic and effective light emission of the end product.

### SUMMARY OF THE INVENTION

In an exemplary embodiment of the invention, a lamp with an inner capsule having lead wires is provided. The lamp comprises an outer envelope, a lamp base at the end of the outer envelope, a stem formed at the base in a location predetermined relative to the outer envelope, and lead-out wires protruding out of the stem. The inner capsule has a pinch portion and lead-in wires protruding out of the inner capsule at least partially parallel to the central plane of the pinch portion. The lead-in wires and the lead-out wires constitute pairs of lead wires providing mechanical and electrical connection between the stem and the inner capsule. Each pair of lead wires comprises a substantially straight wire of a predetermined diameter and a spooled wire of a spooling core diameter being not smaller than said predetermined diameter, and the pairs are mounted by pushing the straight wire through the core of the spooled wire. The pairs are at the opposite sides of the pinch portion centrally symmetrically to its axis.

In exemplary embodiments of other aspects of the invention, a lamp with an inner capsule having lead wires is provided. The lamp comprises an outer envelope, a lamp base at the end of the outer envelope, a stem formed at the base in a location predetermined relative to the outer envelope, and lead-out wires protruding out of the stem. The inner capsule has a pinch portion and lead-in wires protruding out of the inner capsule at its end. The lead-in wires have a part deviating from the central plane of the pinch portion toward the two opposite sides of the pinch portion in its thickness, and have at least one part being parallel to the central plane of the pinch portion, or alternatively the lead-out wires have a part deviating from the central plane of the flattened upper part of the stem, and have at least one part being parallel to the central plane of the upper part of the stem. The lead-in wires and the lead-out wires constitute pairs of lead wires providing electrical connection between the stem and the inner capsule and also providing mechanical support on both opposite sides of the pinch portion or alternatively of the stem. Each pair of the lead wires comprises a substantially straight wire of a predetermined diameter and a spooled wire of a spooling core diameter being not smaller than said predetermined diameter, and the pairs are mounted by pushing the straight wire through the core of the spooled wire.

This arrangement provides the required mechanical stiffness of this mount structure. The mounted pair can be strengthened by spot welding, for example at two opposite spots.

Such pair of lead wires can be arranged in different allocation to the stem and the capsule, thus enabling to find an optimum, simple and reliable manufacturing and mounting technology. The end product is shock-resistant due to the connecting construction. As an addition, the overall length of the lamp can be smaller since the stem and the capsule can be placed very close to each other.

### BRIEF DESCRIPTION OF DRAWINGS

The invention will now be described with reference to the enclosed drawings, where

FIG. 1 is a lamp in partial sectional view,

FIG. 2 is a front view of a pinch portion of a capsule and a stem connected by two pairs of lead wires,

FIG. 3 is a front view of a pair of the lead wires in unassembled position,

FIG. 4 is a front view of a modified pair of the lead wires of FIG. 3, in unassembled position,

FIG. 5 is a front view of a stem with straight lead-out wires,

FIG. 6 is a side view of the stem of FIG. 5,

FIG. 7 is a front view of a further embodiment of a stem with spooled lead-out wires,

FIG. 8 is a side view of the stem of FIG. 7,

FIG. 9 is a front view of an embodiment of a mounted stem with a capsule,

FIG. 10 is a side view of the embodiment of FIG. 9,

FIG. 11 is a top view of the embodiment of FIG. 9,

FIG. 12 is a top view of the embodiment of FIG. 10,

FIG. 13 is a front view of a further embodiment of a mounted stem with a capsule,

FIG. 14 is a side view of the embodiment of FIG. 13,

FIG. 15 is a top view of the embodiment of FIG. 13,

FIG. 16 is a top view of the embodiment of FIG. 14,

FIG. 17 is a front view of a further embodiment of a mounted stem with a pinch portion of the capsule,

FIG. 18 is a side view of the embodiment of FIG. 17,

FIG. 19 is a top view of the embodiment of FIG. 17, and

FIG. 20 is a top view of the embodiment of FIG. 18.

### DETAILED DESCRIPTION OF THE INVENTION

Same reference numbers identify same functional elements of different embodiments in the drawings.

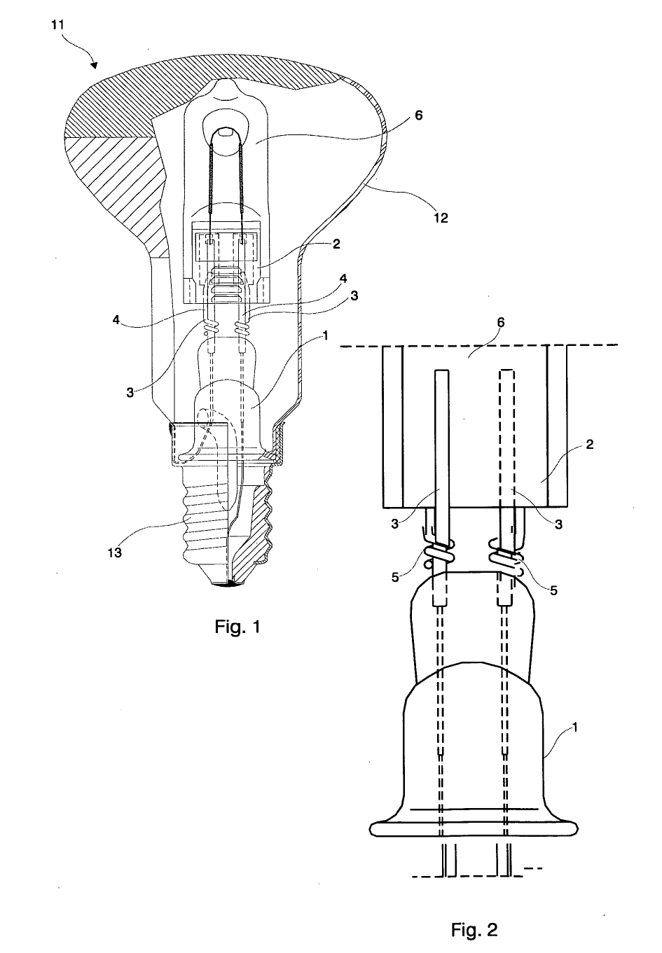

In FIG. 1, a lamp 11 with an inner capsule 6 having lead wires can be seen. The lamp 11 has an outer envelope 12 with a base 13 at its lower end. A stem 1 is formed at the top of the base 13 in a known way, and made of some glass material. In the mounted state of the lamp 11, the location of the stem 1 is predetermined relative to the outer envelope 12. Lead-out wires 4 protrude out of the stem 1 with one end, while the other end of the lead-out wires 4 provide electrical coupling to the base 13. The inner capsule 6 has a pinch portion 2 and lead-in wires 3 protrude out of the inner capsule 6 in such a manner, that at least relevant parts of them are parallel to the central plane of the pinch portion 2. The lead-in wires 3 and the lead-out wires 4 are connected to each other and constitute pairs of lead wires which have a function to provide mechanical and electrical connection between the stem 1 and the inner capsule 6 in their jointly mounted state.

Referring now to FIG. 2, there is shown a detail of a lamp, for example the lamp 11 of FIG. 1, including a construction with a stem 1 and a connected inner capsule 6 or as often called inner burner. There are lead-out wires 4 protruding out of the stem 1. The inner capsule 6 has a known pinch portion 2 at its lower end where that is provided with lead-in wires 3 for the purpose of mechanical and electrical connection to the lead-out wires 4. The lead-in wires 3 protrude out of the inner capsule 6 partially parallel to the central plane of the pinch portion 2. This means that the lead-in wires 3 have significant parts, which are parallel to the central plane of the pinch portion 2. However, some small parts of the lead-in wires 3 are guided in a direction transversal to the central plane of the pinch portion 2. The pinch portion 2 is substantially plain and has a relatively small thickness. The two lead-in wires 3 protruding out of the end of the pinch portion 2 are formed to deviate from the central plane of the pinch portion 2 toward the two opposite sides of the pinch portion 2 regarding in its thickness. This deviation is just as little as it makes possible to support mechanically the pinch portion 2 on both sides by the fitted lead-out wires 4 after mounting the inner capsule 6.

The connected lead-out wire 4 and lead-in wire 3 constitute a pair of lead wires. In FIG. 2, two such pairs are shown, symmetrically on both sides of the drawing. One pair is before the central plane of the pinch portion 2, and the other is behind that plane.

In one embodiment, the lead-in wires 3 protrude out of the inner capsule 6 at the end of the pinch portion 2 and extend on opposite sides of the pinch portion 2. Either one of said pairs can be applied in such a way that a part of one of the pairs shall overlap the pinch portion. This has an advantage that the pinch portion 2 is mechanically supported on both sides by the lead-in wires 3 or by the lead-out wires 4, depending on the different possible embodiments.

FIG. 3 illustrates a pair of the lead wires 7, 8 according to an exemplary embodiment of the invention. One of them, the lead wire 8 is straight with a predetermined diameter. The other lead wire 7 is a spooled wire having a spooled part 5 of length L1, where the spooling core diameter is not smaller than the diameter of the lead wire 8. This means that the diameters are about the same, or the spooling core diameter is slightly larger. In a typical embodiment, the lead wires 7 and 8 are of 0.4-1.5 mm in diameter. In this case, the spooling core diameter preferably exceeds said diameter of the straight wire 8 by 0-0.2 mm. If the spooling core diameter exceeds the diameter of the straight wire 8 by 0-0.1 mm, the mechanical connection is more reliable. The pitch of the coil may be, for example, 1.5-2.5 mm, and the electrode distance of the lead wires 7 may be between 4 and 8 mm. Different sizes, of course, can be adapted to different lamps.

The lead wire 7 can be formed by known spooling technology. This can be applied to a wire, which has already been inserted in a glass made element 9 like a stem or a capsule. Before the spooling step, the essentially straight wire is to be grabbed tightly at a length. Due to this technology, the resulted lead wire 7 comprises a first straight part of a straightly protruding length L2 and a subsequent spooled part 5 of a spooling length L1, as it can be seen in FIG. 3.

The other lead wire 8 can be introduced during mounting the lamp into the core of the spooled part of lead wire 7. This may provide in itself a good mechanical and electrical connection, but a spot welding is preferably used on the spooled part 5. Two welding points at opposite parts of the spooled part 5 may result in a very steady fixation. The other lead wire 8 is also attached to a glass made element 9.

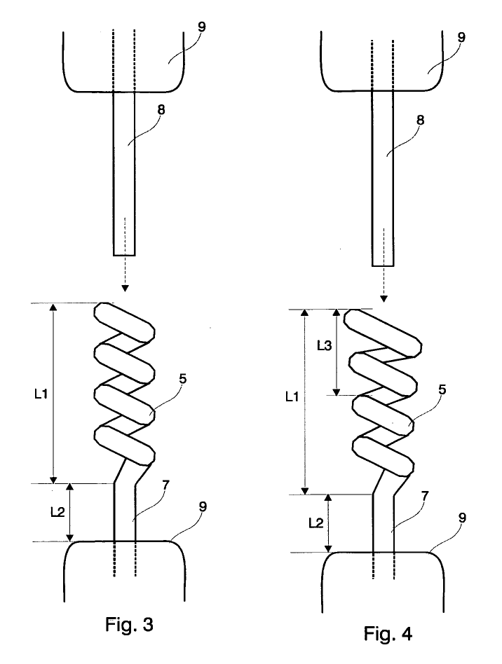

For promoting easy introduction of the other lead wire 8, a conical widening of the spooled part 5 may be used at its free end portion, in an introducing length L3, as illustrated in FIG. 4. This may form a funnel, which guides the straight lead wire 8 to push through the core of the spooled part 5. The straight lead wire 8 will be stuck along the length L1 of the spooled part 5 rather than its part of said introducing length L3.

It is an important aspect that it is not defined which half of the pair is the lead-in wire and which is the lead-out wire. They can be commuted reciprocally. Thus the glass made elements 9 in FIG. 3 or in FIG. 4 can either be the stem or the capsule from this point of view.

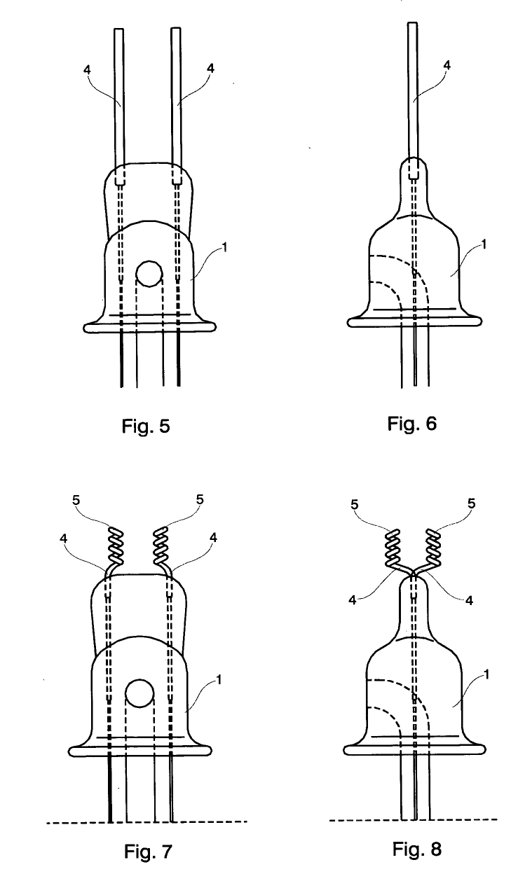

In FIGS. 5 and 6, a stem 1 is shown in front and side views, respectively. Two straight lead-out wires 4 protrude out from the upper part of the stem 1. As shown in FIG. 6 the upright lead-out wires 4 are formed in the central plane of the stem 1. In this case, these constitute the straight halves of the pairs of the lead wires. The spooled halves must be formed on the counterpart capsule.

FIGS. 7 and 8 show an alternative arrangement where the stem 1 carries the lead-out wires 4 of the spooled part 5. In this embodiment, the straight halves of the pairs are located on the capsule, connected to usual electric elements encapsulated in a known manner in the inner burner capsule.

FIGS. 9 and 10 are front and side views, respectively, of a mounted stem 1 with a typical kind of capsule 6, used in lamps mounted with single ended inner burner capsule, such as, for example, Haloreflectors. The lead-out wires 4 of the stem 1 are pushed through the spooled part 5 of the lead-in wires 3, which are reversely leaned back. In this embodiment, the lower end of the pinch portion 2 can be very close to the upper end of the stem 1 in the mounted state of the lamp. It is to be noted that this may reduce the overall length of the lamp. The spooled part 5 in the mounted state of the lamp overlaps the pinch portion 2 along at least ⅓, preferably between ⅓ and ⅔ length of the pinch portion.

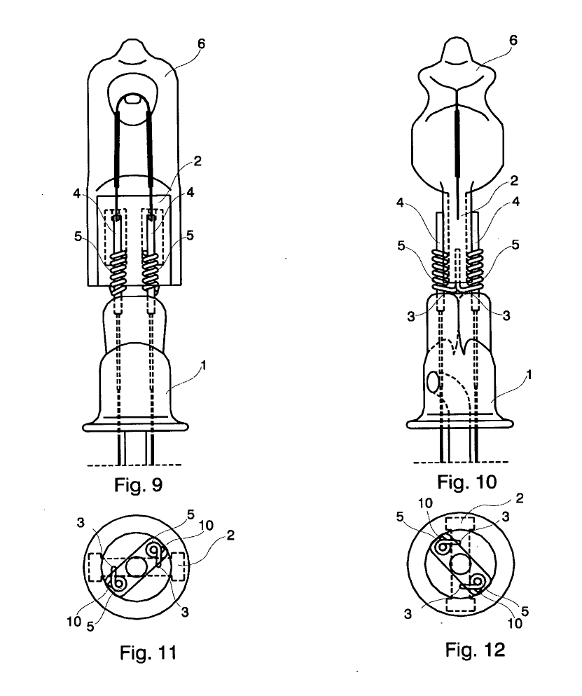

FIGS. 11 and 12 are top views of the embodiment of FIGS. 9 and 10, respectively. The main body of the capsule is not shown in order to illustrate the junction of the lead wires of the lamp more clearly. The spooled part 5 has a remaining straight ending 10. This is derived from the spooling technology applied to the lead-in wire 3 before bending back. In order to diminish the risk of electric discharge between the separate spooled parts 5, the remaining straight endings 10 protrude in an opposite direction relative to the lead wires of the other spooled part 5. The two lead-in wires 3, as being ones of two pairs of lead wires according to an exemplary embodiment of the present invention, protrude out of the inner capsule 6 at the lower end of the pinch portion 2, and after leaning back extend on opposite sides of the pinch portion 2. This arrangement is advantageous to promote the support of pinch portion 2 on both sides, thus supporting the capsule 6 itself. The shock-resistance is thus enhanced.

Where the lead-in wires 3 are leaned back in opposite direction, a part is created in each lead wire that deviates from the central plane of the pinch portion 2, just toward the two opposite sides thereof. The other parts of the lead-in wires 3 can be considered parallel to the pinch portion 2.

Depending on the location of this bent, the lead-in wire 3 is supported by the lead-out wire 4 directly by its part over the spooled part 5 or indirectly by the intermediate turns of the spooled part 5 being between the lead-out wire 4 and the pinch portion 2 and overlapping the latter. In the embodiment of FIGS. 9-12, all of the turns of the spooled part 5 are in supporting contact with the pinch portion 2.

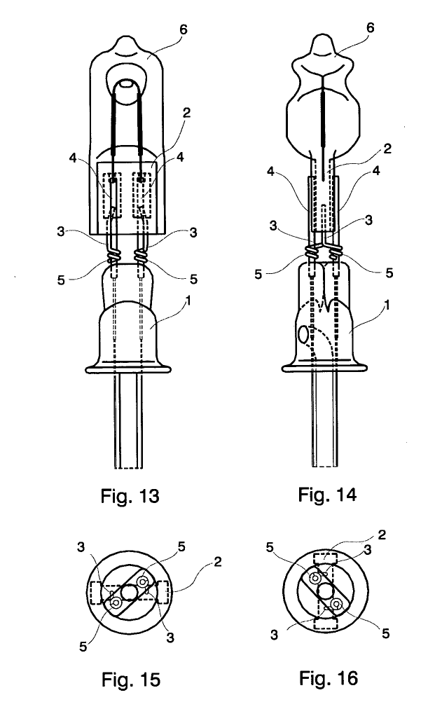

FIGS. 13 and 14 are similar to FIGS. 9 and 10, respectively, with the difference that the lead-in wires 3 in this embodiment are not leaned back, but extend straight toward the stem 1. The lead-out wires 4 of the stem 1 are pushed through this spooled part 5 of the lead-in wires 3 similarly to those in the embodiment of FIGS. 9-12, but the opposite sides of the pinch portion 2 are now supported by the lead-out wires 4 directly. For this purpose, the protruding length of the lead-in wires 3 and that of the lead-out wires 4 are tailored in such a manner that once the spooled parts 5 have been pushed onto the lead-out wires 4 fully, the upright lead-out wires 4 get in contact with the opposite sides of the pinch portion 2. Preferably, the lead-out wires 4 overlap the pinch portion along at least ⅓ length, or even more preferably between ⅓ and ⅔ lengths of the pinch portion.

In FIGS. 15 and 16, bottom views of the embodiment of FIGS. 13 and 14, respectively, can be seen, where the main body of the capsule is not shown in order to illustrate the junction of the lead wires of the lamp more clearly. The lead-in wires 3, protruding out of the inner capsule 6 at their end, have a part deviating from the central plane of the pinch portion 2 toward the two opposite sides thereof. At the same time, the lead-in wires 3 have parts being parallel to the central plane of the pinch portion 2. This is the case for the lead-in wires 3 of FIG. 14 after the place where they leave the end of the pinch portion 2. The spooled parts 5 can also be considered as parts being parallel to the central plane of the pinch portion 2, with regard to their core axle.

The spooled part 5 in all of the previously described embodiments is spooled with several turns. At least, however, somewhat more than one full turn around the counterpart element of the pair is considered sufficient.

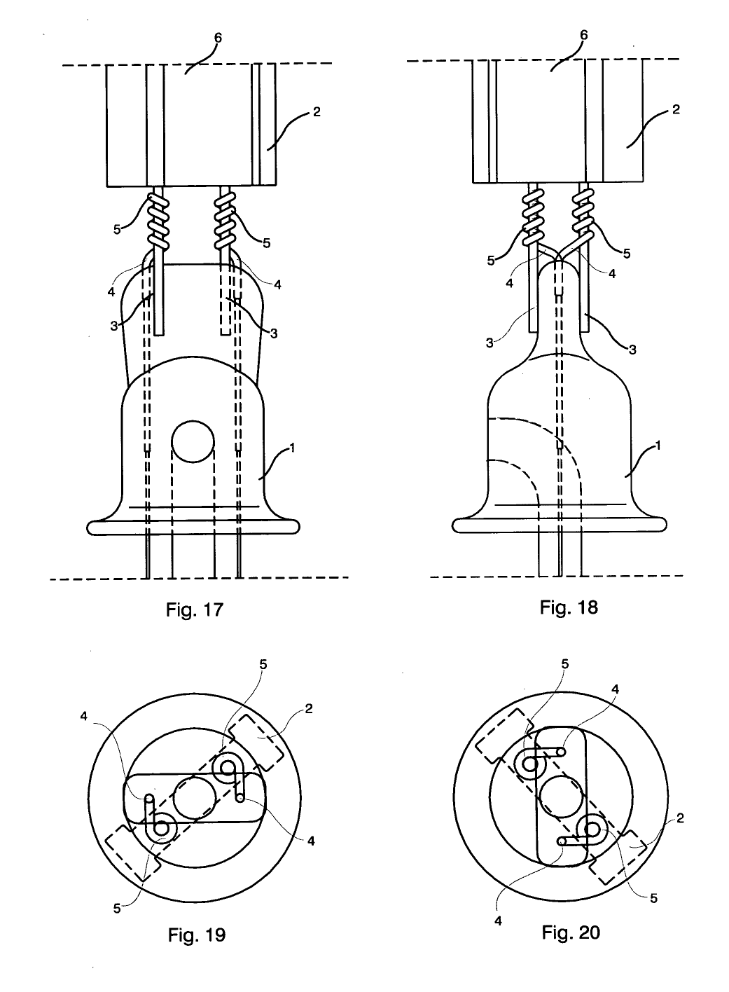

The roles of the pinch portion and the stem, i.e. those of the lead-in and led-out wires are reversible. Any of them may comprise the necessary part deviating from the central plane of the stem or the pinch portion—in order to provide the purported mechanical support—toward the two opposite sides of the counterpart element of the stem or the pinch portion, respectively. Of course, the lead wires including said deviating parts also include at least one part being parallel to the central plane of the stem, as mentioned before with respect to the equivalent embodiment of supporting the pinch portion on both sides. FIGS. 17-20 illustrate this possible further embodiment of the invention. FIG. 17 is a front view of said embodiment, FIG. 18 is a side view, FIG. 19 is a top view of the embodiment of FIG. 17, and FIG. 20 is a top view of the embodiment of FIG. 18. The stem 1 has an upper part flattened along a central plane. The lead-out wires 4 protrude out of this upper part of the stem 1 in the central plane, and have a part deviating from the central plane toward the two opposite sides of the flattened upper part of the stem 1 in its thickness. The lead-out wires 4, however, have at least one part being parallel to the central plane of the upper part of the stem 1. Two parts parallel to the central plane may also be possible, before and after said deviating part. The straight protruding lead-in wires 3 in this case support the opposite sides of the upper part of the stem 1, from which the upright lead-out wires 4 protrude in a manner providing guidance by the spooled parts 5 on opposite sides of the upper part of the stem 1.

The foregoing have been illustrative, but non-limiting examples of the practice of the invention. As will be appreciated by those skilled in the art, other configurations and lamp constructions may be practiced, including single-ended lamps of the type illustrated in the drawings. Those skilled. in the art will also appreciate that the invention is also applicable to lamps made of any glass material, including the outer envelope and the inner capsule as well.

1. A lamp with an inner capsule having lead wires, the lamp comprising:
an outer envelope;
a lamp base at the end of the outer envelope;
a stem formed at the base in a location predetermined relative to the outer envelope;
lead-out wires protruding out of the stem;
the inner capsule having a pinch portion and lead-in wires protruding out of the inner capsule at least partially parallel to the central plane of the pinch portion;
the lead-in wires and the lead-out wires constitute pairs of lead wires providing mechanical and electrical connection between the stem and the inner capsule;
each pair of the lead wires comprising a substantially straight wire of a predetermined diameter and a spooled wire of a spooling core diameter being not smaller than said predetermined diameter, and the pairs being mounted by pushing the straight wire through the core of the spooled wire.

2. The lamp of claim 1, in which said pairs support mechanically the pinch portion on its both opposite sides.

3. The lamp of claim 1, in which the mounted pairs of lead wires are welded together.

4. The lamp of claim 3, in which the mounted pairs of lead wires are welded together in at least two substantially opposite point of the spooling.

5. The lamp of claim 1, in which said substantially straight wire is the lead-in wire and said spooled wire is the lead-out wire.

6. The lamp of claim 1, in which said substantially straight wire is the lead-out wire and said spooled wire is the lead-in wire.

7. The lamp of claim 1, in which said predetermined diameter of the straight wire is in the range of 0.4-1.5 mm.

8. The lamp of claim 7, in which said spooling core diameter of the spooled wire exceeds said predetermined diameter of the straight wire by 0-0.2 mm.

9. The lamp of claim 1, in which two lead-in wires as elements of two pairs of lead wires protrude out of the inner capsule at the end of the pinch portion, and extend straight toward the stem.

10. The lamp of claim 1, in which two lead-in wires as elements of two pairs of lead wires protrude out of the inner capsule at the end of the pinch portion, and extend leaned back on opposite sides of the pinch portion, being substantially parallel to and supporting the pinch portion.

11. The lamp of claim 1, in which the spooled wire has a first straight part of a straight protruding length and a subsequent spooled part of a spooling length.

12. The lamp of claim 11, in which said spooling length overlaps the pinch portion along at least ⅓ length of the pinch portion.

13. The lamp of claim 12, in which said spooling length overlaps the pinch portion along ⅓ to ⅔ length of the pinch portion.

14. The lamp of claim 11, in which said spooling length is greater than said straight protruding length.

15. The lamp of claim 11, in which the spooled part has a conically widening funnel like end portion.

16. The lamp of claim 11, in which the spooled part has a remaining straight ending.

17. The lamp of claim 16, in which said remaining straight ending protrudes in an opposite direction relative to the other lead wires straight ending.

18. A lamp with an inner capsule having lead wires, the lamp comprising:
an outer envelope;
a lamp base at the end of the outer envelope;
a stem formed at the base in a location predetermined relative to the outer envelope;
lead-out wires protruding out of the stem;
the inner capsule having a pinch portion and lead-in wires protruding out of the inner capsule at its end, the lead-in wires having a part deviating from the central plane of the pinch portion toward the two opposite sides of the pinch portion in its thickness, and having at least one part being parallel to the central plane of the pinch portion;
the lead-in wires and the lead-out wires constitute pairs of lead wires providing mechanical and electrical connection between the stem and the inner capsule and also providing mechanical support on both opposite sides of the pinch portion;
each pair of lead wires comprising a substantially straight wire of a predetermined diameter and a spooled wire of a spooling core diameter being not smaller than said predetermined diameter, and the pairs being mounted by pushing the straight wire through the core of the spooled wire.

19. The lamp of claim 18, in which two lead-in wires as the spooled wires of two pairs of lead wires protrude out of the inner capsule at the end of the pinch portion, and extend leaned back on opposite sides of the pinch portion, being substantially parallel to and supporting the pinch portion.

20. The lamp of claim 19, in which said spooled wires overlap and support both sides of the pinch portion along at least ⅓ length of the pinch portion.

21. The lamp of claim 20, in which said spooled wires overlap and support both sides of the pinch portion along ⅓ to ⅔ length of the pinch portion.

22. The lamp of claim 18, in which two lead-in wires as halves of two pairs of lead wires protrude out of the inner capsule at the end of the pinch portion and extend toward the stem, and the counterpart other halves of the pairs provide mechanical support on both opposite sides of the pinch portion.

23. The lamp of claim 22, in which the counterpart other halves of the pairs overlap and support the sides of the pinch portion along at least ⅓ length of the pinch portion.

24. The lamp of claim 22, in which the counterpart other halves of the pairs are spooled wires.

25. The lamp of claim 22, in which the counterpart other halves of the pairs are straight wires.

26. A lamp with an inner capsule having lead wires, the lamp comprising:
an outer envelope;
a lamp base at the end of the outer envelope;
a stem formed at the base in a location predetermined relative to the outer envelope and having an upper part flattened along a central plane;
lead-out wires protruding out of the upper part of the stem in its central plane; the lead-out wires having a part deviating from the central plane of the stem toward the two opposite sides of the flattened upper part of the stem, and having at least one part being parallel to the central plane of the upper part of the stem;
the inner capsule having a pinch portion and straight lead-in wires protruding out of the pinch portion at its end;
the lead-in wires and the lead-out wires constitute pairs of lead wires providing mechanical and electrical connection between the stem and the inner capsule and also providing mechanical support on both opposite sides of the stem;
each pair of lead wires comprising a substantially straight wire of a predetermined diameter and a spooled wire of a spooling core diameter being not smaller than said predetermined diameter, and the pairs being mounted by pushing the straight wire through the core of the spooled wire.
